(19) United States
(12) Patent Application Publication
(10) Pub. No.: US 2023/0203359 A1
(43) Pub. Date: Jun. 29, 2023

(54) PHASE CHANGE MATERIAL SCREENING

(71) Applicant: HUBBARD PRODUCTS LIMITED, Suffolk (GB)

(72) Inventors: Yulong DING, Birmingham (GB); Lin CONG, Birmingham (GB); Derek CHAPMAN, Suffolk (GB); Boyang ZOU, Birmingham (GB)

(73) Assignee: HUBBARD PRODUCTS LIMITED, Suffolk (GB)

(21) Appl. No.: 18/000,366

(22) PCT Filed: Jun. 1, 2021
(86) PCT No.: PCT/GB2021/051347

§ 371 Date: Nov. 30, 2022

(30) Foreign Application Priority Data
Jun. 1, 2020 (GB) 2008200.4

(51) Int. Cl. C09K 5/06

(52) U.S. Cl. CPC C09K 5/066

(57) ABSTRACT

A method of formulating a ternary salt-water solution having a target phase change temperature—the ternary salt-water solution having a first salt, a second salt and water—includes: identifying at three or more temperatures, a maximum total concentration of the first and second salts in a saturated solution thereof, and the respective concentration of each salt therein, correlating the respective concentration of each salt therein with temperature, predicting a concentration for each of the salts at the target phase change temperature using the correlations, and formulating a ternary salt-water solution with a concentration of the first and second salts based on the predicted concentrations at the target phase change temperature. The method is suitable for phase change material screening, and in particular identifying and optimising phase change materials which can be used as cold storage materials.

### FIELD OF THE INVENTION

The present invention relates to a method for identifying a ternary salt-water solution having a target phase change temperature. In particular, the present invention relates to a method for formulating a ternary salt-water solution which is stable when used as or in a phase change material. The method is particularly suitable for identifying and optimising phase change materials which are suitable for use as cold storage materials.

### BACKGROUND TO THE INVENTION

Phase change materials absorb significant amounts of thermal energy during melting and, conversely, release thermal energy during freezing, Thus, phase change materials typically have a high latent heat, i.e. the energy required to convert a solid into a liquid without the material changing in temperature.

Phase change materials are useful in a large number of different applications one of which is cold storage. Here, the phase change material is cooled to a temperature below its phase change temperature so that it is in a solid form. The solid phase change material will then cool its surrounding environment. Due to the high latent heat, a large amount of thermal energy is absorbed from the environment during transition of the material from a solid to a liquid at its phase transition temperature. This means that phase change materials are very effective at maintaining cool environments over a long period of time.

Phase change materials are therefore used in many domestic and commercial cold storage applications, particularly where electrically powered refrigeration systems are unavailable. For instance, one or more plastic or metal containers holding a phase change material may be used to maintain a cold environment in a vehicle during transportation of perishable goods such as foodstuffs and medicines.

Typically, a phase change material will be frozen, used, refrozen, used and so on in a cycling refrigeration process. For instance, the phase change material may be frozen in a container overnight, with the container inserted into a cold storage vehicle in the morning for delivery of perishables during the day and removed from the vehicle at the end of the day for refreezing of the phase change material overnight.

Phase change materials typically contain a liquid base and a number of additives. The liquid base usually makes up the bulk of the phase change material and, for the most part, determines the phase change properties of the material, e.g. its latent heat and phase change temperature. It will be appreciated that the “liquid base” is in a solid form when the phase change material is in a frozen form. Additives are often included to modify other properties of the phase change material, e.g. its viscosity or thermal conductivity.

Phase change materials with a phase change temperature in the range of −15 to −40° C. are useful for cold storage application. However, cost-effective formulations having a desired combination of properties in this temperature range have been difficult to formulate. In the past, paraffins, alcohol solutions and binary salt-water solutions have most commonly been used as the base liquid in low-cost formulations. However, organic materials may suffer from poor levels of latent heat, suffer from bacterial growth and/or even be toxic. Inorganic salt solutions will often exhibit a higher latent heat, but the range of phase change temperatures available with binary salt-water solutions is limited.

Some of these problems may be overcome using ternary salt-water solutions. Since ternary salt-water solutions contain two salts, the range of phase change temperatures available widens considerably. For all their benefits, ternary salt-water solutions suffer from a number of drawbacks. One of the main drawbacks is that have a tendency to separate during use into different phases, usually caused by an excess of one of the salts being present in the system. This can lead to degradation of the phase change material, an inconsistent phase change temperature and decreased energy density.

In order to avoid phase separation during use, large numbers of experiments on ternary salt-water solutions are carried out as part of a product development stage. The concentrations of the salts in the ternary salt-water solutions are slightly tweaked in each experiment so that an optimum formulation may be identified.

Typical experiments include differential scanning calorimetry (DSC) where a single defined peak indicates a stable eutectic solution. However, each DSC experiment is time-consuming, particularly where high quality results are desired, and a very large number of experiments are required to hone in on the optimised solutions.

Another method involves wet residue experiments, with Schreinemaker's method used to analyse the results. However, analytical and geometrical errors may occur in this method. This may be due to, for instance, solvent losses in the open environment, temperature fluctuation during liquid/solid phase transferring, and measurement uncertainty associated with the titration. The use of below 0° C. temperatures further increases the operating complexity.

There is therefore a need for improved phase change materials, particularly for use in cold storage applications where a phase change temperature in the range of −15 to −40° C. is desired.

### SUMMARY OF THE INVENTION

In a first aspect, the present invention provides A method for formulating a ternary salt-water solution having a target phase change temperature—the ternary salt-water solution containing a first salt, a second salt, and water—said method comprising:
(a) identifying, at three or more temperatures, a maximum total concentration of the first and second salts in a saturated solution of the first and second salts, and the concentration of the first and second salts in the saturated solution having said maximum total concentration;
(b) correlating the concentration of each of the first and second salts in the saturated solution at said maximum total concentration with temperature;
(c) predicting a concentration for each of the first and second salts at the target phase change temperature using the correlations; and
(d) formulating a ternary salt-water solution having a concentration of first and second salts based on the predicted concentrations at the target phase change temperature.

Further provided is a method for preparing a phase change material, said method comprising:
formulating a ternary salt-water solution using the method of the present invention; and
blending the ternary salt-water solution with one or more components selected from a gelling agent, a nucleation agent, and a conductivity enhancement agent.

Ternary salt-water solutions and phase change materials obtainable by the methods of the present invention are also provided.

### DESCRIPTION OF THE FIGURES

FIG. 1 shows the phase change temperature of salt-water solutions which are made of up different ratios of sodium chloride and ammonium chloride eutectic solutions, as measured using differential scanning calorimetry (DSC).

FIG. 2 shows a method of the present invention that has been carried out on a sodium chloride-ammonium chloride ternary salt-water solution. Specifically, FIG. 2a shows the step of determining the saturated concentration of a ternary salt-water system at a number of different temperatures. FIG. 2b shows linear, second order polynomial, and fourth order polynomial correlations between saturated concentration and temperature, and their extrapolation to the target phase change temperature. FIG. 2c shows the saturated concentration of the ternary salt-water system at the target phase change temperature.

FIG. 3 shows the graph from FIG. 2c onto which data points have been added relating to the concentration by weight of sodium chloride and ammonium chloride when different volumetric ratios of their eutectic solutions are combined.

FIG. 4 shows the phase change temperatures, as measured using DSC, of different salt-water solutions formulated using the method of the present invention. Specifically, FIG. 4a shows the phase change temperature of salt-water solution formulated based on the second and fourth order polynomial correlations formulations and the linear correlation formulation. FIG. 4b shows the phase change temperature of salt-water solution formulated by mixing different volumetric ratios of sodium chloride and ammonium chloride eutectic solutions.

FIG. 5 shows a graph of temperature against time during DSC for salt-water solutions formulated using the method of the present invention (the second and fourth order polynomial correlations formulations and the linear correlation formulation) and by mixing different volumetric ratios of sodium chloride and ammonium chloride eutectic solutions.

### DESCRIPTION OF VARIOUS EMBODIMENTS

The present invention relates to a method for formulating a ternary salt-water solution which may be used as, or in, a phase change material.

The Ternary Salt-Water Solution

Ternary salt-water solutions are well known in the art as salt-water solutions in which two salts (i.e. a first salt and a second salt) are used. Thus, ternary salt-water solutions consist of three components: the first salt, the second salt and water.

The ternary salt-water solution is preferably a eutectic solution. Eutectic solutions are well known in the art as multi-component systems that melt and solidify at a single temperature that is lower than the melting point of any of the constituents.

In preferred embodiments, the cations or the anions in the first and second salts are the same. More preferably, the anions in the first and second salts are the same. By using the same cation or anion in the salts, a more defined phase change temperature may be observed in the ternary salt-water solution, perhaps because reactions between the first and second salts in the phase change material are avoided.

The cations in the first and second salt may be selected from alkali metal (e.g. lithium, sodium and potassium), alkaline earth metal (e.g. calcium and magnesium), transition metal (e.g. zinc, iron and copper) and ammonium cations. In some circumstances, however, the use of transition metal salts may be avoided since these can be corrosive. Thus, the cations are preferably selected from alkali metal, alkaline earth metal, and ammonium cations, and more preferably from alkali metal and ammonium cations, such as sodium and ammonium cations.

The anions in the first and second salt may be selected from nitrate, sulfate, hydrogen sulfate, thiosulfate, phosphate, hydrogen phosphate, dihydrogen phosphate, carbonate, hydrogen carbonate, hydroxide, formate, acetate and halide (e.g. chloride, bromide and iodide) anions. Preferred anions are halides, such as chloride.

The first and second salts, and any further salts that may form part of the salt-water solution, may be organic or inorganic salts. Preferably, the salts are inorganic salts since these tend to inhibit microbial growth, and exhibit good thermal performance.

In preferred embodiments, the first salt is sodium chloride (NaCl). The first salt may be combined with a second salt selected from ammonium chloride (NH₄Cl), potassium chloride (KCl) and sodium sulfate (Na₂SO₄), and preferably from ammonium chloride and potassium chloride.

In particularly preferred embodiments, the first salt is sodium chloride and the second salt in ammonium chloride. It has surprisingly been found that this combination, in a ternary salt-water solution, exhibits a phase change temperature of approximately −25° C., and a high latent heat, making it highly suitable for use in low-temperature cold storage applications.

Selection of the First and Second Salt

The method of the present invention may include a step of selecting a first salt. The first salt may be selected because a eutectic solution of the first salt exhibits a phase change temperature which is higher than, but preferably still fairly close to, the target phase change temperature of the ternary salt-water solution. It will be appreciated that references herein to a eutectic solution of the first salt and a eutectic solution of the second salt are references, respectively, to a eutectic binary salt-water solution of the first salt and a eutectic binary salt-water solution of the second salt, i.e. the solutions consist solely of the salt in question and water.

The first salt may be selected because the phase change temperature of a eutectic solution of the first salt may be at least 1° C., preferably at least 1.5° C., and more preferably at least 2° C. higher than the target phase change temperature of the ternary salt-water solution. The first salt may be selected because the phase change temperature of a eutectic solution of the first salt may be up to 10° C., preferably up to 7° C., and more preferably up to 5° C. higher than the target phase change temperature of the ternary salt-water solution. Thus, the first salt may be selected because the phase change temperature of a eutectic solution of the first salt may be from 1 to 10° C., preferably from 2 to 7° C., and more preferably from 2.5 to 5° C. higher than the target phase change temperature of the ternary salt-water solution.

Where multiple first salts are identified as having a suitable phase change temperature, the one with the highest latent heat may be selected.

The method of the present invention may also include a step of selecting a second salt. The second salt may be selected because eutectic solutions of the first and second salts exhibit phase change temperatures which are close to one another. These combinations give a more significant lowering of the phase change temperature of the ternary salt-water solution.

The second salt may be selected because eutectic solutions of the first and second salts exhibit phase change temperatures within 10° C., preferably within 8° C., and more preferably within 6° C. of one another. The second salt may be selected because a eutectic solution of the second salt exhibits a phase change temperature which is higher than that of a eutectic solution of the first salt, e.g. by at least 1° C., preferably by at least 2° C., and more preferably by at least 3° C. Thus, the second salt may be selected because a eutectic solution of the second salt exhibits a phase change temperature which is from 1 to 10° C., preferably from 2 to 8° C., and more preferably from 3 to 6° C. higher than that of a eutectic solution of the first salt.

Where multiple second salts are identified as having a suitable phase change temperature, the one with the highest latent heat may be selected.

The second salt may be selected because a eutectic solution of the second salt exhibits a latent heat which is higher than that of a eutectic solution of the first salt, e.g. by at least 10 10 kJ/kg, preferably by at least 25 kJ/kg, and more preferably by at least 50 kJ/kg.

Other considerations may also be involved, such as compatibility of the cations and anions in the first and second salts (discussed in more detail above), as well as toxicity and corrosivity of the salts.

Any of the phase change temperatures and latent heats described herein may be measuring using differential scanning calorimetry (DSC), e.g. using a method as detailed in the examples. Preferably, the phase change temperatures described herein are determined using, for example, ASTM E794-06(2018), DIN 51004 1994 or ASTM D3418-15, and calibration may be performed according to ASTM E967-18, and latent heats described herein are determined using, for example, ASTM E793-06(2018) or ASTM D3418-15, and calibration may be performed according to ASTM E968-02(2014).

Of course, the phase change temperature (and its closeness to the target phase change temperature) and the latent heat (higher being better) of the ternary salt-water solution that is formed using the first and second salts are also important. An indication of these may be obtained by mixing eutectic solutions of different first and second salts in different ratios.

For instance, where multiple first salts are selected, the method may comprise forming a series of ternary salt-water solutions by combining a eutectic solution of each of the first salts with a eutectic solution of each of at least two second salts. For instance, where two first salts are selected, and three second salts are screened, the series of solutions will be made up of six ternary salt-water solutions. Where two first salts are selected, and five second salts are screened, the series of solutions will be made up of 10 ternary salt-water solutions.

The method may also comprise preparing ternary-salt water solutions containing different ratios of a eutectic solution of a first salt to a eutectic solution of a second salt for each pair of first and second salts. For instance, where two first salts are selected and five second salts are screened, and three different ratios of first eutectic solution to second eutectic solution are tested for each salt pair, the series of ternary salt-water solutions will be made up of 30 ternary salt-water solutions.

The phase change temperature and, preferably also the latent heat, of each of the ternary salt-water solutions in the series may then be determined, e.g. using DSC, and first and second salts selected for further investigation in steps (a)-(d) of the method of the present invention.

The first and second salts may be selected because a ternary salt-water solution consisting of a eutectic solution of the first salt and a eutectic solution of the second salt has a phase change temperature within 3° C., preferably within 2° C., and more preferably within 1° C. of the target phase change temperature of the ternary salt-water solution.

Where multiple ternary salt-water solutions are identified has having a suitable phase change temperature, the first and second salts may be selected because a ternary salt-water solution containing said salts exhibits the highest latent heat.

The target phase change temperature of the ternary salt-water solution will, of course, vary depending on the specific application for which the ternary salt-water solution is intended. The target phase change temperature of the ternary salt-water solution is preferably one that makes it suitable for certain cold storage applications. For these applications, the target phase change temperature of the ternary salt-water solution ternary salt-water solution may therefore be −15° C. or lower, preferably −20 or lower, and more preferably from −24 or lower.

The target phase change temperature of the ternary salt-water solution may be −40° C. or higher, preferably −30° C. or higher, and more preferably −26° C. or higher. Thus, the target phase change temperature of the ternary salt-water solution may be from −40° C. to −15° C., preferably from −30 to −20° C., and more preferably from −26 to −24° C.

However, the principle of the invention may be applied more broadly, for instance to ternary salt-water solutions having a target phase change temperature of from −70 to 0° C.

Step (a)—Saturated Concentration of Ternary Salt-Water Systems

In step (a) of the method of the present invention, a maximum concentration of the first and second salts in a saturated solution of the first and second salts is identified at three or more temperatures. The concentration of the first and second salts in the saturated solution at said maximum total concentration is also identified.

A saturated solution at a given temperature is a solution in which more solute cannot be dissolved. Thus, if further solute is added to the solution, it will remain as a solid. The saturated solutions in part (a) are saturated ternary salt-water solutions consisting of the first and second salts and water. For the purposes of the present invention, a solution is therefore considered to be saturated at a given temperature if the addition of either the first and second salts leads to insoluble material being present. In other words, if the solution is saturated, solid will precipitate irrespective of whether the first salt or second salt is added.

A number of different fully saturated solutions may exist at the same temperature. For instance, where salt A is dissolved in an amount of x grams, it will be possible to dissolve y grams of salt B. But where salt A is dissolved in an amount of x′ grams, the amount of salt B that can be dissolved may be different: y′ grams. At any given temperature, there is a saturated solution in which the total concentration (by weight) of salts A and B is maximised. This maximum total concentration, and the concentration of salts A and B in the maximally saturated solution, is identified in step (a).

In some instances, this information may be directly obtained from literature. However, it is more usual for the information to be determined. Thus, in preferred embodiments, the maximum total concentration of the first and second salts at each temperature is determined (along with the concentrations of the first and second salts at the maximum total concentration) from measurements of the concentrations of the first and second salts in at least two saturated solutions in which the amount of first and/or second salt varies.

Preferably, the information is determined from at least three, and more preferably at least five, saturated solutions in which the amount of first and second salt varies. Preferably, one of the saturated solutions contains only the first salt, and one of the saturation solutions contains only the second salt.

In some embodiments, the method of the present invention may comprises carrying out equilibrium solubility experiments to determine the concentrations of the first and second salts in different saturated solutions. For instance, an amount of the first salt may be dissolved in a volume of water, and then second salt added until solids are observed. In preferred embodiments, further of the first salt may then be added to see whether this concentration may be increased further before solids are observed.

Methods for carrying out equilibrium solubility experiments are known in the art, and the specific method that is adopted is not crucial. It is, however, preferred that the same method is carried out on each of the saturated solutions. As an example, for a certain temperature, the equilibrium solubility experiments may be conducted under stirring with solute added at a rate of 0.1 g of salt per 100 g of solvent per minute. Precipitation is monitored visually. When precipitation occurs, the amount and nature of the precipitate (i.e. proportion of first and second salts) is preferably verified (e.g. using known analytical techniques) and the concentrations of the first and second salts in the saturated solution determined accordingly (it is possible that more precipitate will form than the 0.1 g of salt per 100 g of solvent that has just been added if the solution was in a supersaturated state).

However, since there is extensive literature regarding the solubility of multi-salt saturated solutions, it is not usually necessary to carry out solubility experiments. Indeed, the availability of this data helps to make the method of the present invention quick and simple. Thus, it is generally preferred that the concentrations of the first and second salts in different saturated solutions is determined from literature reports of solubility experiments.

In some embodiments, the concentrations of the first and second salts in saturated solutions in which the amount of first and/or second salt varies may be represented in a graph of concentration of the second salt against concentration of the first salt (or vice versa). Two straight lines may be plotted through the data, with the point at which the lines intersect representing the concentrations of the first and second salts at the maximum total concentration. Alternatively, the maximum total concentration may simply be taken as the saturated solution which, of those for which data is available, contains the highest total amount of first and second salt.

The maximum total concentration of the first and second salts in a saturated solution (along with the concentrations of the first and second salts at the maximum total concentration) is determined at three or more temperatures. This provides sufficient data points for a correlation to be drawn in step (b). However, in preferred embodiments, the maximum total concentration is obtained at at least four, preferably at least six, and more preferably at least 8 temperatures.

Typically, the temperatures at which the maximum total concentrations (along with the corresponding concentrations of the first and second salts at each maximum total concentration) are identified are at least 5° C., preferably at least 7° C., and more preferably at least 10° C. higher than the target phase change temperature. This is to reduce the chances of any phase change occurring at the temperatures at which the concentration of the first and second salts is determined.

However, since the correlation between temperature and the concentration of first and second salts in a saturated solution can move away from linear as temperatures reduce, the maximum total concentration of the first and second salts in a saturated solution (along with the concentrations of the first and second salts at the maximum total concentration) is preferably determined at at least one, and preferably at least two, and more preferably at least three temperatures of up to 20° C. At least one of these temperatures is preferably up to 10° C., and more preferably up to 0° C.

Step (b)—Correlating First and Second Salt Concentration with Temperature

In step (b) of the method of the present invention, the concentrations of the first and second salts determined in step (a), i.e. concentrations of the first and second salts in the saturated solution having the maximum total concentration of first and second salts, are each correlated with temperature.

Generally, as temperature increases, a larger amount of salt will be present in a dissolved state in a saturated solution. A computer program may be used to generate the correlation, such as Excel (Microsoft) or Origin (OriginLab Corporation).

The correlation in step (b) may be selected from linear and polynomial correlations (i.e. polynomials with a degree of two or more). However, as the correlations at temperatures below zero and/or close to the target phase change temperature may move away from linear, the correlation is preferably a polynomial correlation, such as a second, third, fourth or fifth order polynomial correlation (i.e. polynomials having a degree of two, three, four or five). Though the most accurate correlation will, of course, depend on the first and second salts, a fourth order polynomial correlation has been found to be effective.

It will be appreciated that the correlation between the concentration of the first salt with temperature will be different from the correlation between the concentration of the second salt with temperature. However, the degree of polynomial correlation is preferably the same for the first and second salts. So when a fourth order correlation is determined between the concentration of the first salt and temperature, a fourth order correlation will also be determined between the second salt and temperature.

In some embodiments, the method of the present invention comprises testing at least two, and preferably at least three, different correlations and selecting one of the correlations. The correlation may be selected because it is most closely aligns with the data obtained in step (a); this could be determined visually, e.g. by inspecting a graph, or by using a computer program. As mentioned below, the preferred correlation may also be selected using other criteria as part of step (c).

Step (c)—Predicting Saturated Concentration at Target Phase Change Temperature

In step (c) of the method of the present invention, a concentration for each of the first and second salts at the target phase change temperature is predicted using the correlations determined in step (b).

The preferred ratio of the first salt to the second salt will, of course, be determined using the method of the present invention. However, the preferred ratio, by weight, will typically be within the range of 1:1 to 4:1, particularly where the first salt is selected because a eutectic solution of the first salt has a phase change temperature higher, but preferably close to, the target phase change temperature of the ternary salt-water solution.

The total content of salt in the ternary salt-water solution will similarly be determined using the method of the present invention. The ternary-salt water solution will generally contain the first and second salts in a total amount of at least 20%, preferably at least 25%, and more preferably at least 30% by weight. These salt loadings are higher than that those typically obtained by other methods, e.g. by mixing eutectic solutions of the first and second salt.

The latent heat of the ternary salt-water solution will preferably be higher than that of a eutectic solution of the first salt. The latent heat of the ternary salt-water solution may be at least 10 kJ/kg, preferably at least 20 kJ/kg, and more preferably at least 30 kJ/kg higher than that of a eutectic solution of the first salt.

As mentioned above, step (b) may comprise determining more than one correlation. In these embodiments, step (c) may comprise: (i) predicting a concentration for each of the first and second salts at the target phase change temperature using each of the correlations determined in step (b); and (ii) selecting a preferred concentration for each of the first and second salts at the target phase change temperature for use in step (d). The preferred concentrations of the first and second salts selected in step (c)(ii) preferably correspond to the concentrations predicted using one of the correlations.

Step (c)(ii) may, in a first embodiment, comprise selecting the preferred concentration of first and second salts based on measurements of the phase change temperature of at least three mixtures of eutectic salt-water solutions of the first and second salts. For instance, the preferred concentration of the first and second salts may be selected because the ratio of the first and second salts in the preferred concentration is the closest to the ratio of the first and second salts in the mixture of first and second eutectic solutions showing the most promising eutectic profile. A promising eutectic profile may be exhibited by a system that melts and solidifies at a single temperature.

As described elsewhere herein, the phase change temperature in step (c)(ii) may be obtained using differential scanning calorimetry. In some embodiments, the method of the present invention comprises measuring the phase change temperature of the at least three mixtures of eutectic salt-water solutions of the first and second salts.

It will be appreciated that the ratio of the eutectic solution of the first salt and the eutectic solution of the second salt varies in the different mixtures. Preferably, the phase change temperature of at least five, and more preferably at least 10 mixtures is used in step (c)(ii).

Step (c)(ii) may, in a second embodiment, comprise selecting the preferred concentration of first and second salts because a ternary salt-water solution containing said preferred concentration exhibits a higher latent heat of enthalpy than a ternary salt-water solution containing other concentrations of the first and second salts predicted in step (c)(i). Latent heat of enthalpy may be measured using differential scanning calorimetry.

In a third embodiment, step (c)(ii) comprises selecting two preferred concentrations of first and second salts following the first embodiment method (i.e. based on phase change temperature measurements of at least three mixtures of eutectic salt-water solutions of the first and second salts), and then selecting one of said two preferred concentrations following the second embodiment method (i.e. based on latent heat of enthalpy measurements).

Step (d)—Formulating the Ternary Salt-Water Solution

In step (d) of the method of the present invention, a ternary salt-water solution is formulated having a concentration of first and second salts based on the concentrations of the first and second salts predicted at the target phase change temperature in step (c). Where step (b) comprises determining more than one correlation, the preferred predicted concentration for each of the first and second salts is used in step (d).

The ternary salt-water solution may be formulated using known methods in which the first and second salts and water are combined in amounts which give the predicted concentrations. The ternary salt-water solution may be mixed, e.g. by stirring, and/or heated to speed up dissolution of the first and second salts.

The present invention also provides ternary salt-water solutions obtainable, and preferably obtained, using the method of the present invention.

A Method for Preparing a Phase Change Material

The ternary salt water solution formulated using the method of the present invention may be used as, or in, a phase change material. Thus, the present invention provides a method for preparing a phase change material, said method comprising: formulating a ternary salt-water solution using the method of the present invention; and blending the ternary salt-water solution with one or more phase change material components.

The one or more phase change material components may be selected from a gelling agent, a nucleation agent, and a conductivity enhancement agent. In some embodiments, the method for preparing a phase change material may comprise blending the ternary salt-water solution with a gelling agent, a thermal conductivity enhancer and a nucleation agent. These embodiments are particularly preferred when the phase change material is used as a cold storage material.

Where a gelling agent is used, blending may comprise preparing a pre-mixture of all of the components in the phase change material apart from the gelling agent, and then adding the gelling agent to the mixture. By carrying out a pre-mixing step, an even dispersion of components may be obtained before the gelling agent is added.

The phase change material may comprise the ternary salt-water solution in an amount of at least 90%, preferably at least 92%, and more preferably at least 93% by weight. The phase change material may comprise the ternary salt-water solution in an amount of up to 97%, preferably up to 96.5%, and more preferably up to 96% by weight. Thus, the phase change material may comprise the ternary salt-water solution in an amount of from 90 to 97%, preferably from 92 to 96.5%, and more preferably from 93 to 96% by weight.

The phase change material will generally comprise water in an amount of at least 55%, preferably at least 60%, and more preferably at least 65% by weight. For the purposes of the present invention, all of the water in the phase change material forms part of the ternary salt-water solution, though it may be added to the phase change material as a carrier for one or more of the other components that may be present. In other words, the preferred proportions of water and salts in the ternary salt-water solution may be formed in situ.

The use of water in such high amounts, though desirable from an economic perspective, has typically been avoided. This is because its low viscosity means that phase change materials with a high water content are particularly prone to leaking from a cold storage material container, e.g. at the inlet or outlet or a damaged portion. This problem may be addressed by using a gelling agent in the phase change material.

Gelling agents increase the viscosity of the phase change material. Gelling agents can function by chemically interacting with the water in the phase change material thereby changing its properties, or by forming a three-dimensional gel network in which water is trapped. Gelling agents may be used to suspend a nucleation agent and/or to reduce the likelihood of leaks from a container.

Suitable gelling agents may be selected from organic gelling agents (e.g. carboxymethyl cellulose, polyacrylamide, starch and xanthan), silica dioxide and mixtures thereof. CMC is particularly suitable.

The phase change material may comprise the gelling agent in an amount of at least 1%, preferably at least 2%, and more preferably at least 3% by weight. The phase change material may comprise the gelling agent in an amount of up to 8%, preferably up to 7%, and more preferably up to 6% by weight. Thus, the phase change material may comprise the gelling agent in an amount of from 1 to 8%, preferably from 2 to 7%, and more preferably from 3 to 6% by weight. It will be appreciated that, where more than one gelling agent is used, these amounts refer to the total amount of gelling agent in the phase change material.

The use of a gelling agent in these amounts would usually be avoided as excessively gelled phase change materials may suffer from low thermal conductivity and uneven temperature distribution. However, these drawbacks may be offset in the present invention by the use of thermal conductivity enhancers and nucleation agents.

Nucleation agents provide a nucleus around which the salt-water solution may solidify during freezing of the phase change material before use. This is particularly beneficial when the phase change material is eutectic in nature, since the precipitate that is often observed in supersaturated solutions (and which acts as a nucleation agent) will not be present. The use of a nucleation agent in the present invention reduces the extent to which the phase change material needs to be cooled below its phase transition temperature before it solidifies (i.e. it reduces supercooling). It will be appreciated that nucleation enhancers are preferably present as solids in the phase change material, though they may also be materials that precipitate from solution above the phase transition temperature.

Suitable nucleation agents may be selected from isotypic nucleation agents (e.g. borax), non-isotypic nucleation agents (e.g. dilatometer and silica) and mixtures thereof. Isotypic nucleation agents are preferred, in particular borax.

The phase change material may comprise the nucleation agent in an amount of at least 0.05%, preferably at least 0.1%, and more preferably at least 0.25% by weight. The phase change material may comprise the nucleation agent in an amount of up to 2%, preferably up to 1%, and more preferably up to 0.75% by weight. Thus, the phase change material may comprise the nucleation agent in an amount of from 0.05 to 2%, preferably from 0.1 to 1%, and more preferably from 0.25 to 0.75% by weight. It will be appreciated that, where more than one nucleation agent is used, these amounts refer to the total amount of nucleation agent in the phase change material.

Thermal conductivity enhancers are materials which improve heat transfer through the phase change material. Thermal conductivity enhancers are typically present as solids—even if dispersed as e.g. nano-scale particles—in the phase change material.

Suitable thermal conductivity enhancers may be selected from carbon-based materials (e.g. graphite such as expansion graphite, carbon nanotubes and carbon fibres), metal-based materials (e.g. metal powder), carbides, and combinations thereof, though other thermally conductive materials that are compatible with the phase change material may also be used. The thermal conductivity enhancer may be in the form of micro- or nano-scale particles. However, metal-based materials are preferably avoided since these can lead to higher levels of corrosion. Accordingly, preferred thermal conductivity enhancers are selected from carbon-based materials and carbides, with carbon-based materials particularly preferred.

The phase change material may comprise the thermal conductivity enhancer in an amount of at least 0.05%, preferably at least 0.1%, and more preferably at least 0.25% by weight. The phase change material may comprise the thermal conductivity enhancer in an amount of up to 2%, preferably up to 1%, and more preferably up to 0.75% by weight. Thus, the phase change material may comprise the thermal conductivity enhancer in an amount of from 0.05 to 2%, preferably from 0.1 to 1%, and more preferably from 0.25 to 0.75% by weight. It will be appreciated that, where more than one thermal conductivity enhancer is used, these amounts refer to the total amount of thermal conductivity enhancer in the phase change material.

One advantage of the present invention is that, unlike many prior art cold storage materials, the phase change material may be substantially free from organic acids, organic acid anhydrides and organic esters. In some embodiments, the phase change material is substantially free from all organic compounds having a molecular weight of less than 200 Da. For the purposes of the present invention, substantially free indicates less than 0.1% by weight and preferably less than 0.01% by weight.

The phase change material preferable has a phase change temperature within 2° C., preferably within 1° C., and more preferably within ° C., of the target phase change temperature of the ternary salt-water solution.

The phase change material preferably exhibits a high latent heat of enthalpy. The phase change material may have a latent heat of enthalpy of greater than 150 kJ/kg, preferably greater than 175 kJ/kg, and more preferably greater than 200 kJ/kg.

The present invention also provides phase change materials obtainable, and preferably obtained, using the method of the present invention.

The phase change material may be used as a cold storage material. The cold storage material may be for maintaining an environment at a temperature of from −15 to −40° C. These environments are particularly suitable for storing cold-chain products including perishable goods such as foodstuffs and medicines.

Before use, the phase change material is cooled to a temperature below its phase change temperature so that it is in a solid form. During use, energy is absorbed from the surroundings by the phase change material, thereby cooling the environment. Since the phase change materials of the present invention may exhibit a high latent heat of enthalpy, they may absorb a lot of energy from their surrounding before the transition from a solid to liquid state at their phase change temperature is complete. Once the phase change material has been used, it is preferably cooled once again to below its phase change temperature for further use.

One of the advantages of the present invention is that it may be used to identify and formulate phase change material which exhibit good cycling stability, meaning that they can be reused many times with minimal loss of performance. For instance, a phase change material may be subjected to at least 10, preferably at least 20, and more preferably at least 30 cycles from solid to liquid to solid whilst still maintaining the same phase change temperature (e.g. ±5° C. as compared to the material before the first cycle) and the same latent heat (e.g. ±10 kJ/kg as compared to the material before the first cycle). This is unlike many prior art cold storage materials which can lose efficacy with use.

### EXAMPLES

The present invention will now be illustrated by way of the following non-limiting examples.

In the examples, phase change temperature was measuring using differential scanning calorimetry (DSC). Samples for analysis using DSC were prepared by placing approximately 1 to 10 mg of the sample in a 40 μl aluminium crucible. DSC was carried out using a Mettler Toledo DSC2+ with the following settings: temperature range of 25 to −60° C. and a heating/cooling rate of 5° C./min, An endothermic peak or exothermic peak indicated the occurance of the phase change. The collected data was analysed with the analysis software by Mettler Toledo.

Latent heat of enthalpy was also measured using DSC, using the method outlined above in connection with phase change temperature.

Polynomial correlations were determined using Excel or Origin.

T-history experiments were conducted following the method in Zhang et al., Meas. Sci. Technol., 1999, 10(3), 201-205.

### Example 1: Pre-Selection of Sodium Chloride and Ammonium Chloride

Ternary salt-water solutions were screened to identify preferred candidates for use in a cold storage phase change material applications where a chilled environment of −20° C. is desired. To give these temperatures, the ternary salt-water solution would ideally exhibit a phase change temperature of around −25° C.

Sodium chloride was selected as a first salt for use in a ternary salt-water solution, due to its high fusion heat and phase change temperature of between −22 and −23° C., i.e. slightly higher than but close to the target phase change temperature of −25° C.

Eutectic solutions of sodium chloride and variety of different second salts, in ratios of first:second eutectic salt solutions of from 3:1 to 1:3, were then tested. Though a variety of second salts were screened, each of the second salts either had a sodium cation or a chloride anion to minimise the risk of new salts forming. The phase change temperature and latent heat of the different ternary salt-water solutions were assessed using differential scanning calorimetry (DSC). Based on the results, ammonium chloride was identified as a suitable second salt.

### Example 2: Formulating a Ternary Salt-Water Solution

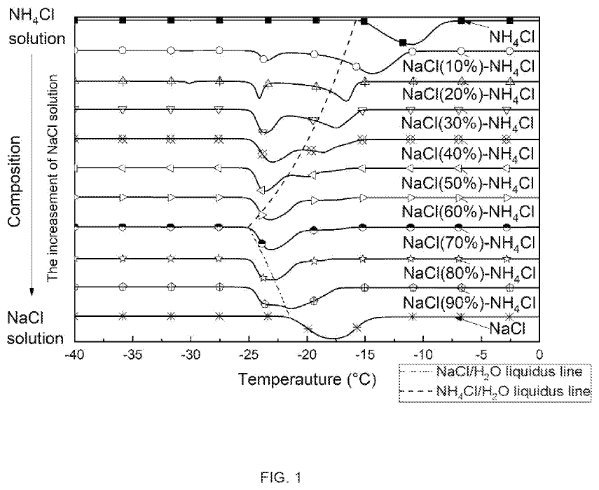

DSC experiments were conducted to determine the ratio at which eutectic solutions of sodium chloride and ammonium chloride were most stable. The results of the DSC experiments are shown in FIG. 1.

Multiple or broad peaks indicate that the phase change temperature is not well defined, thus, that the system may be prone to instability. Multiple peaks can be seen where the eutectic solution of sodium chloride is used in an amount up to 50%, and at least 90%, by volume. However, it is difficult to determine which ratio of sodium chloride to ammonium chloride is most stable between 60 and 80% by volume of sodium chloride.

Thus, a different method was adopted for optimising the ternary salt-water solution.

Step (a)—Saturated Concentration of Ternary Salt-Water Systems

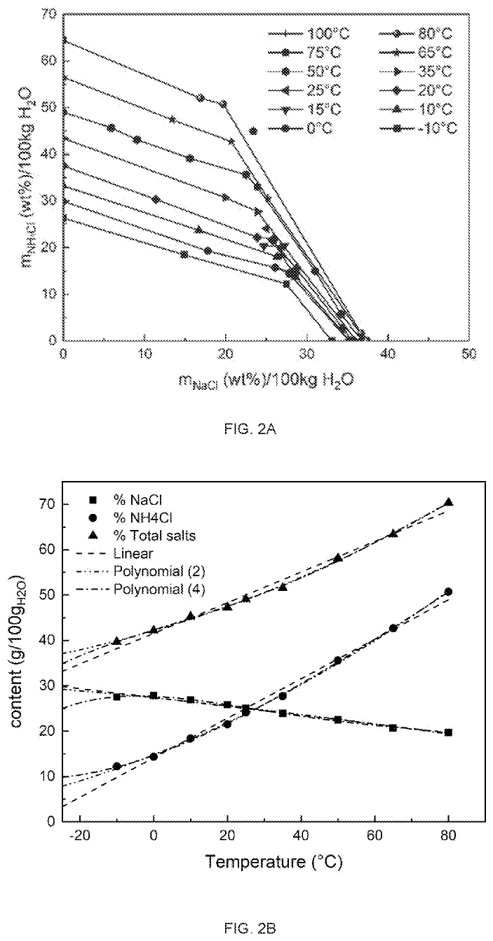

In step (a), the maximum total concentrations (wt %) of sodium chloride and ammonium chloride in ternary salt-water solutions containing different amounts of the salts were determined across a range of temperatures. In this case, the concentrations of the salts in the solutions were derived from literature, though they could have alternatively been determined using simple solubility experiments. A graph of the findings is shown in FIG. 2a.

For each temperature, it can be seen that lines drawn between the data points for each temperature exhibit the same trend: two largely straight lines intersect at a single point—this point represents the maximum total salt content at a certain temperature. For instance, at a temperature of 80° C., it can be seen that the maximum total salt content of about 70% by weight occurs when the concentration of sodium chloride is just under 20% by weight and the concentration of ammonium chloride is slightly over 50% by weight.

Step (b)—Correlating Saturated Concentration with Temperature

In step (b), the saturated concentrations of sodium chloride and ammonium chloride for the data point which represented the maximum total salt content was correlated with temperature. A correlation was also carried out for the total salt concentration at this data point.

Three different correlations were tried: a linear correlation, a second order polynomial correlation and a fourth order polynomial correlation. The results are plotted as a graph in FIG. 2b.

It can be seen that the second and fourth order polynomial correlations fit better with the data points than the linear correlation. The fourth order polynomial appears to have the best fit, though this was subjected to further validation.

Step (c)—Predicting Saturated Concentration at Target Phase Change Temperature

The concentration required for each of the first and second salts at the target phase change temperature of around −25° C. was determined using the linear, second and fourth order polynomial correlations determined in step (b). The required concentrations are depicted in the graph shown in FIG. 2c.

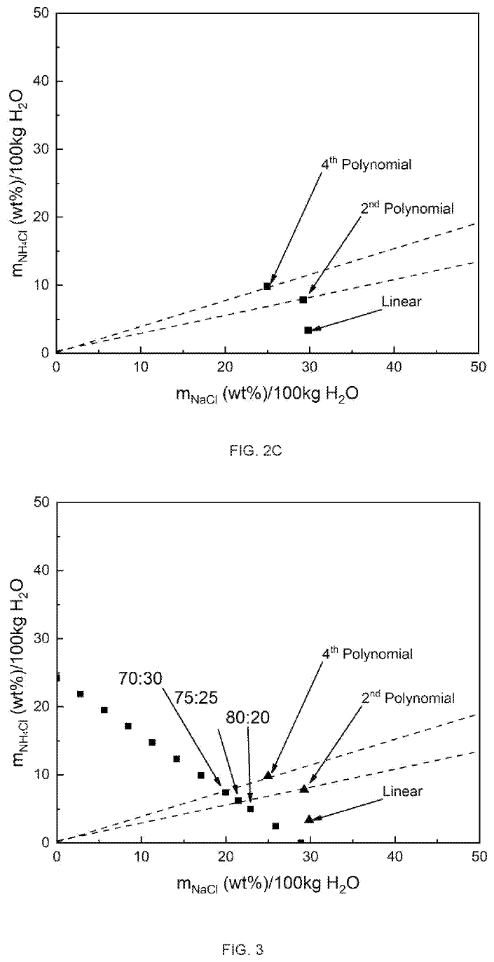

FIG. 3 shows the graph from FIG. 2a, but with a data set added which shows the % wt of the different salts when eutectic solutions of sodium chloride and ammonium chloride are mixed. It can be seen that a higher total amount of salt is included in the ternary salt-water solution when the method of the present invention is used as compared to methods in which eutectic solutions are combined.

FIG. 3 also shows that the ratio of salts derived from the second and fourth order polynomial correlations is similar to the ratio where 70 to 80% by volume of a eutectic sodium chloride solution has been mixed with 20 to 30% by volume of a eutectic ammonium chloride solution, thereby further suggesting that these correlations provide superior results to the linear correlation.

Step (d)—Formulating the Ternary Salt-Water Solution

Ternary salt-water solutions were formulated having the concentrations of sodium chloride and ammonium chloride determined in step (c). The materials were formulated by combining water with the salts and stirring the mixture.

### Example 3: Efficacy of the Identified Ternary Salt-Water System /Validating the Results

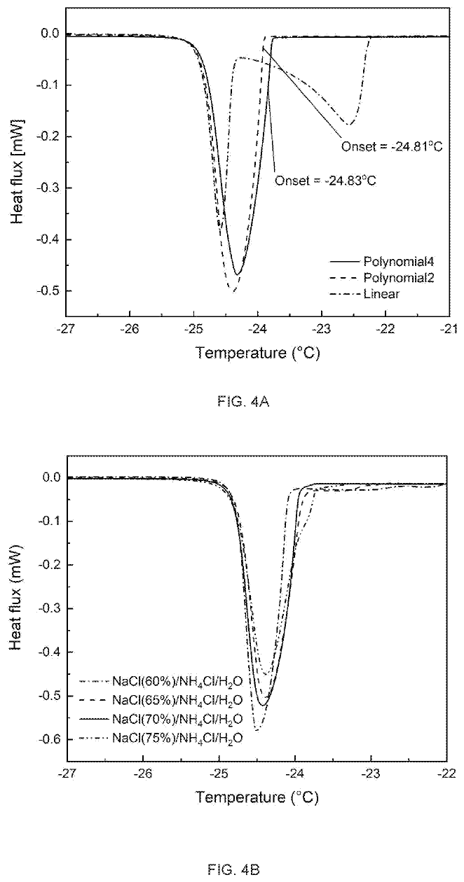

The correlations determined in step (b) of Example 3 suggest that the ternary salt-water material formulated according to the fourth order polynomial correlation will be the best performing material. In order to test this hypothesis, DSC experiments were carried out on the materials prepared in step (d) of Example 3, as well as solutions in which 60:40, 65:35, 70:30 and 75:25 by volume ratios of eutectic solutions of sodium chloride and ammonium chloride are employed. In order to obtain accurate results, a DSC heating rate of 0.1° C./minute was adopted. The results are shown in FIG. 4.

It can be seen that the formulations prepared using second and fourth order polynomials have a single, well-defined DSC peak, whereas the linear correlation formulation has two DSC peaks. This further supports the finding that use of linear correlations is less accurate than polynomial correlations. It can also be seen that, aside from when a ratio of 70:30 by volume is used, the mixtures of eutectic solutions give less well-defined DSC peaks (see also the liquidus lines of NaCl/H₂O and NH₄Cl/H₂O in FIG. 1 which intersect where 70% by volume of the eutectic solution sodium chloride is used). It can be seen from FIG. 3 that it is the fourth order polynomial formulation that sits on the extension line of the 70:30 ratio line, thereby suggesting that the fourth order polynomial formulation is the preferred ternary salt-water solution.

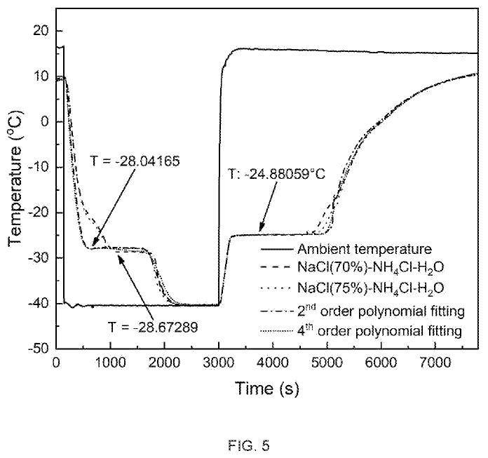

FIG. 5 shows a graph of temperature observed during T-history experiments against time. It can be seen that the second and fourth order polynomial formulations exhibit longer platform during melting process, which indicates that both polynomial formulations have superior fusion heat to the linear formulation and the formulations which are mixtures of eutectic solutions. The fourth order polynomial formulation appears to show the largest latent heat.

Accordingly, these results validate the findings of step (b) of Example 2.

1. A method for formulating a ternary salt-water solution having a target phase change temperature—the ternary salt-water solution containing a first salt, a second salt, and water—said method comprising:
(a) identifying, at three or more temperatures, a maximum total concentration of the first and second salts in a saturated solution of the first and second salts, and the concentration of the first and second salts in the saturated solution having said maximum total concentration;
(b) correlating the concentration of each of the first and second salts in the saturated solution at said maximum total concentration with temperature;
(c) predicting a concentration for each of the first and second salts at the target phase change temperature using the correlations; and
(d) formulating a ternary salt-water solution having a concentration of first and second salts based on the predicted concentrations at the target phase change temperature.

2. The method of claim 1, wherein the ternary salt-water solution is a eutectic solution.

3. The method of claim 1, wherein the cations or the anions, in the first and second salts are the same.

4. The method of claim 1, wherein:
the cations in the first and second salt may be selected from alkali metal (e.g. lithium, sodium and potassium), alkaline earth metal (e.g. calcium and magnesium), transition metal (e.g. zinc, iron and copper) and ammonium cations, preferably from alkali metal, alkaline earth metal, and ammonium cations, and more preferably from alkali metal and ammonium cations, such as sodium and ammonium cations; and/or
the anions in the first and second salt may be selected from nitrate, sulfate, hydrogen sulfate, thiosulfate, phosphate, hydrogen phosphate, dihydrogen phosphate, carbonate, hydrogen carbonate, hydroxide , formate, acetate and halide (e.g. chloride, bromide and iodide) anions, and preferably from halides, such as chloride.

5. The method of claim 1, wherein the first and second salts are inorganic salts.

6. The method of claim 1, wherein the first salt is selected because the phase change temperature of a eutectic solution of the first salt may be from 1 to 10° C., preferably from 2 to 7° C., and more preferably from 2.5 to 5° C. higher than the target phase change temperature of the phase change material.

7. The method of claim 1, wherein the second salt is selected because a eutectic solution of the second salt exhibits a phase change temperature which is from 1 to 10° C., preferably from 2 to 8° C., and more preferably from 3 to 6° C. higher than that of a eutectic solution of the first salt.

8. The method of claim 1, wherein the first and second salts are be selected because a ternary salt-water solution consisting of a eutectic solution of the first salt and a eutectic solution of the second salt has a phase change temperature within 3° C., preferably within 2° C., and more preferably within 1° C. of the target phase change temperature of the ternary salt-water solution

9. The method of claim 1, wherein the maximum total concentration of the first and second salts at each temperature is determined in step (a) from measurements of the concentrations of the first and second salts in at least two, preferably at least three, and more preferably at least five, saturated solutions in which the amount of first and/or second salt varies.

10. The method of claim 1, wherein the maximum total concentration of the first and second salts in a saturated solution, and the concentrations of the first and second salts at the maximum total concentration, is determined at three or more, preferably four or more, and preferably six or more, temperatures.

11. The method of claim 1, wherein step (a) comprises carrying out equilibrium solubility experiments to determine the concentrations of the first and second salts in different saturated solutions.

12. The method of claim 1, wherein the correlation is step (b) is selected from linear and polynomial correlations, and preferably is a polynomial correlation, and more preferably a fourth order polynomial correlation.

13. The method of claim 1, wherein step (b) comprises determine more than one correlation.

14. The method of claim 13, wherein step (c) comprises: (i) predicting a concentration for each of the first and second salts at the target phase change temperature using each of the correlations determined in step (b); and (ii) selecting a preferred concentration for each of the first and second salts at the target phase change temperature for use in step (d).

15. The method of claim 14, wherein the preferred concentration of first and second salts is selected:
based on measurements of the phase change temperature of at least three, preferably at least five, and more preferably at least 10, mixtures of eutectic salt-water solutions of the first and second salts; and/or
because a ternary salt-water solution containing said preferred concentration exhibits a higher latent heat of enthalpy than a ternary salt-water solution containing other concentrations of the first and second salts predicted in step (c)(i).

16. A ternary salt-water solution obtainable by the method of claim 1.

17. A method for preparing a phase change material, said method comprising:
formulating a ternary salt-water solution using the method of any of claim 1; and
blending the ternary salt-water solution with one or more components selected from a gelling agent, a nucleation agent, and a conductivity enhancement agent.

18. The method of claim 17, wherein the phase change material comprises the ternary salt-water solution in an amount of from 90 to 97%, preferably from 92 to 96.5%, and more preferably from 93 to 96% by weight.

19. The method of claim 17, wherein the gelling agent:
is selected from organic gelling agents (e.g. carboxymethyl cellulose, polyacrylamide, starch and xanthan), silica dioxide and mixtures thereof; and/or
is present in the phase change material in an amount of from 2 to 8%, preferably from 3 to 7%, and more preferably from 4 to 6% by weight.

20. The method of claim 17, wherein the thermal conductivity enhancer:
is selected from carbon-based materials (e.g. graphite such as expansion graphite, carbon nanotubes and carbon fibres), metal-based material (e.g. metal powder), carbides, and combinations thereof; and/or
is present in the phase change material in an amount of from 0.05 to 2%, preferably from 0.1 to 1%, and more preferably from 0.25 to 0.75% by weight.

21. The method of claim 17, wherein the nucleation agent:
is selected from isotypic nucleation agents (e.g. borax), non-isotypic nucleation agents (e.g. dilatometer and silica) and mixtures thereof
is present in the phase change material in an amount of from 0.05 to 2%, preferably from 0.1 to 1%, and more preferably from 0.25 to 0.75% by weight.

22. The method of claim 17, wherein the phase change material preferable has a phase change temperature within 2° C., preferably within 1° C., and more preferably within ° C., of the target phase change temperature of the ternary salt-water solution.

23. The method of claim 17, wherein the phase change material may have a latent heat of enthalpy of greater than 150 kJ/kg, preferably greater than 175 kJ/kg, and more preferably greater than 200 kJ/kg.

24. A phase change material obtainable by the method of claim 17.
